(19) United States
(12) Patent Application Publication
(10) Pub. No.: US 2013/0240033 A1
(43) Pub. Date: Sep. 19, 2013

(54) METHOD FOR PRODUCING COUNTER ELECTRODE BASED ON ELECTROPHORETIC DEPOSITION OF GRAPHENE, COUNTER ELECTRODE PRODUCED BY THE METHOD AND DYE-SENSITIZED SOLAR CELL INCLUDING THE COUNTER ELECTRODE

(71) Applicants: Min-Hyon Jeon, Busan (KR); Hyon-Kwang Choi, Gimhae-si (KR); Sook-Hyun Hwang, Busan (KR); Hyun-Kook Kim, Gimhae-si (KR)

(72) Inventors: Min-Hyon Jeon, Busan (KR); Hyon-Kwang Choi, Gimhae-si (KR); Sook-Hyun Hwang, Busan (KR); Hyun-Kook Kim, Gimhae-si (KR)

(73) Assignee: INJE UNIVERSITY INDUSTRY-ACADEMIC COOPERATION FOUNDATION, Gimhae-si, Gyeongsangnam-do (KR)

(21) Appl. No.: 13/880,739

(22) PCT Filed: May 6, 2011
(86) PCT No.: PCT/KR2011/003372

§ 371 Date: Apr. 22, 2013

(30) Foreign Application Priority Data
Oct. 22, 2010 (KR) 10-2010-0103618

(51) Int. Cl. H01G 9/20; H01G 9/04; F27D 7/06

(52) U.S. Cl. CPC H01G 9/2022; F27D 7/06; H01G 9/04
USPC 136/256; 432/23; 204/491

(57) ABSTRACT

Disclosed is a method for producing a counter electrode based on electrophoretic deposition of graphene. The method includes: adding graphene to a dispersion medium to prepare a graphene dispersion; dipping a transparent electrode in the graphene dispersion and applying a voltage to the transparent electrode for 5 seconds to 5 minutes to deposit the graphene on the transparent electrode; and annealing the graphene-adsorbed transparent electrode at 350 to 600° C. under a nitrogen atmosphere. Also disclosed are a counter electrode produced by the method and a dye-sensitized solar cell including the counter electrode.

### TECHNICAL FIELD

The present invention relates to a method for producing a counter electrode based on electrophoretic deposition of graphene, and more specifically to a method for producing a counter electrode for a dye-sensitized solar cell by electrophoretically depositing graphene, a counter electrode produced by the method, and a dye-sensitized solar cell including the counter electrode.

### BACKGROUND ART

Environmental problems such as global warming arise from increased use of fossil fuels. Further, the use of uranium gives rise to problems such as radioactive contamination and nuclear waste disposal. Thus, energy is needed that can replace fossil fuels and uranium, and research on such alternative energy is being undertaken. As representative examples, solar cells using solar energy are considered.

Solar cells refer to devices that directly produce electricity from light-absorbing materials capable of generating electrons and holes when light is irradiated thereonto. In 1839, the French physicist Becquerel first discovered a photovoltaic phenomenon in which a photo-induced chemical reaction generates an electric current. Thereafter, similar phenomena have been discovered in solids such as selenium. Since the first development of silicon-based solar cells having an efficiency of about 6% by the Bell Laboratories in 1954, research has been continuously conducted on inorganic silicon-based solar cells.

General solar cells using organic materials have the problems of low energy conversion efficiency and poor durability. The dye-sensitized solar cell developed by a research team led by Grätzel from Switzerland in 1991 is a photoelectrochemical solar cell using a dye as a photosensitive agent. The photoelectrochemical solar cell uses an oxide semiconductor composed of photosensitive dye molecules and titanium dioxide nanoparticles. Specifically, the photoelectrochemical solar cell has a structure in which an electrolyte is injected into an organic oxide layer, such as a dye-adsorbed titanium oxide layer, between a transparent electrode and a metal electrode and is operated based on a photoelectrochemical reaction in the structure. A general dye-sensitized solar cell includes two electrodes, an inorganic oxide, a dye, and an electrolyte. Dye-sensitized solar cells are eco-friendly because they use environmentally harmless materials. Dye-sensitized solar cells have an energy conversion efficiency as high as 10%, which is comparable to that of amorphous silicon-based solar cells. The production costs of dye-sensitized solar cells are merely 20% of those of silicon solar cells. It was reported that these advantages increases the likelihood of success in the commercialization of dye-sensitized solar cells.

As described above, dye-sensitized solar cells based on photochemical reactions have a multilayer cell device structure in which an inorganic oxide layer and an electrolyte layer are introduced between a cathode and an anode. Light-absorbing dye molecules are adsorbed to the inorganic oxide layer, and electrons are reduced in the electrolyte layer. A brief explanation will be given regarding a conventional dye-sensitized solar cell device.

A conventional dye-sensitized solar cell may have a multilayer structure including a substrate, a first electrode, a dye-adsorbed titanium oxide layer, an electrolyte, and a second electrode. More specifically, the dye-sensitized solar cell includes a lower substrate, an anode, a dye-adsorbed titanium oxide layer, an electrolyte layer, a cathode as a counter electrode, and an upper substrate laminated in this order from the bottom. Generally, the lower substrate and the upper substrate are made of glass or plastic, the anode is coated with indium-tin oxide (ITO) or fluorine doped tin oxide (FTO), and the cathode is coated with platinum. The counter electrode of the dye-adsorbed titanium oxide is produced by screen printing or pasting using platinum as a major material.

However, platinum as a material for the counter electrode has high performance but is expensive, screen printing necessitates expensive equipment, and pasting is disadvantageous in terms of coating uniformity.

### DISCLOSURE

### Technical Problem

The present invention has been made in view of the above problems, and it is an object of the present invention to provide a method for producing a counter electrode in an economical and easy manner by electrophoretically depositing graphene.

It is another object of the present invention to provide a counter electrode produced based on electrophoretic deposition of graphene.

It is still another object of the present invention to provide a dye-sensitized solar cell employing the counter electrode.

### Technical Solution

According to an aspect of the present invention, there is provided a method for producing a counter electrode, including: adding graphene to a dispersion medium to prepare a graphene dispersion; dipping a transparent electrode in the graphene dispersion and applying a voltage to the transparent electrode for 5 seconds to 5 minutes to deposit the graphene on the transparent electrode; and annealing the graphene-adsorbed transparent electrode at 350 to 600° C. under a nitrogen atmosphere.

According to another aspect of the present invention, there is provided a counter electrode produced by adding graphene to a dispersion medium, dipping a transparent electrode in the graphene dispersion, applying a voltage to the transparent electrode to deposit the graphene on the transparent electrode, and annealing the graphene-adsorbed transparent electrode at 350 to 600° C. under a nitrogen atmosphere.

According to yet another aspect of the present invention, there is provided a dye-sensitized solar cell including a counter electrode wherein the counter electrode is produced by adding graphene to a dispersion medium, dipping a transparent electrode in the graphene dispersion, applying a voltage to the transparent electrode to deposit the graphene on the transparent electrode, and annealing the graphene-adsorbed transparent electrode at 350 to 600° C. under a nitrogen atmosphere.

### Advantageous Effects

The counter electrode of the present invention can be produced using graphene in an easy and economical manner. The inherent characteristics of graphene allow the counter electrode of the present invention to have a large reaction area and a large-area uniform coating. Therefore, the counter electrode of the present invention can substitute for platinum electrode. The dye-sensitized solar cell of the present invention has excellent characteristics such as high current density and efficiency.

### DESCRIPTION OF DRAWINGS

FIG. 1 shows a method for producing a graphene counter electrode based on electrophoresis according to one embodiment of the present invention.

FIGS. 2a to 2c show I-V curves of dye-sensitized solar cells fabricated using graphene counter electrodes, which were produced by the application of different electrophoretic deposition voltages for different times in Examples 1-12.

FIG. 3 shows the efficiency values of dye-sensitized solar cells fabricated using graphene counter electrodes, which were produced in Examples 1-12.

FIGS. 4a to 4d show SEM and TEM images of an FTO substrate used for the production of a counter electrode according to one embodiment of the present invention before and after graphene deposition, a TEM image of the graphene-deposited FTO substrate, and the results of EELS analysis for the graphene-deposited FTO substrate.

FIG. 5 shows the results of thermal gravity analysis for magnesium nitrate and a graphene solution to determine annealing temperatures in the production of a counter electrode according to one embodiment of the present invention.

FIG. 6 shows Nyquist plots of dye-sensitized solar cells fabricated using annealed graphene counter electrodes according to embodiments of the present invention.

FIG. 7 shows bode phase plots of dye-sensitized solar cells fabricated using graphene counter electrodes after annealing at different temperatures according to embodiments of the present invention.

FIG. 8 shows I-V curves of dye-sensitized solar cells fabricated using annealed graphene counter electrodes according to embodiments of the present invention.

FIG. 9 shows XPS data for the surfaces of graphene counter electrodes according to embodiments of the present invention.

FIG. 10 shows transmittance values of graphene counter electrodes according to embodiments of the present invention.

### MODE FOR INVENTION

The present invention will now be described in detail.

In one aspect, the present invention provides a method for producing a counter electrode, including: adding graphene to a dispersion medium to prepare a graphene dispersion; dipping a transparent electrode in the graphene dispersion and applying a voltage to the transparent electrode for 5 seconds to 5 minutes to deposit the graphene on the transparent electrode; and annealing the graphene-adsorbed transparent electrode at 350 to 600° C. under a nitrogen atmosphere.

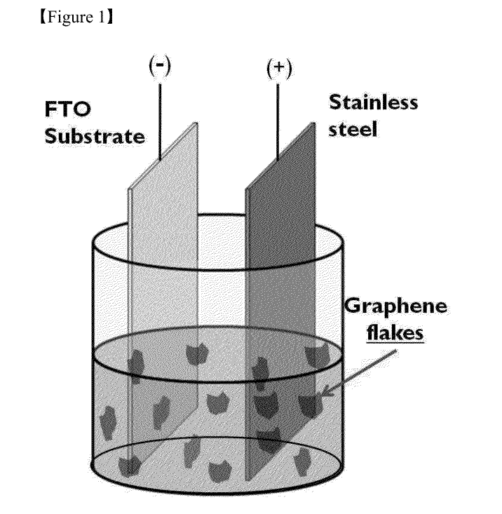

FIG. 1 shows a method for producing a graphene counter electrode based on electrophoresis according to one embodiment of the present invention. Referring to FIG. 1, graphene is mixed with a dispersion medium, a transparent electrode (e.g., an FTO or ITO electrode) and a metal substrate (e.g., a stainless steel or aluminum substrate) acting as an opposite electrode upon deposition are dipped in the graphene dispersion, and a voltage is applied to the electrodes to deposit the graphene on the transparent electrode. Graphene can be synthesized on a large scale at low cost. Other advantages of graphene are high transmittance, large surface area/thickness ratio, and excellent electrocatalytic activity.

Graphene is usually produced by a chemical vapor deposition (CVD) process or a chemical process using a reducing agent. Chemical vapor deposition enables the production of graphene with high quality but requires a temperature of 1,000° C. or higher and is thus time-consuming. Alternatively, graphene may be produced by a chemical process using a reducing agent. According to this chemical process, the reducing agent reduces finely divided graphite oxide to graphene. Graphene produced by a chemical synthesis process is preferably used in the method of the present invention.

Specifically, graphene can be produced through the following chemical synthetic process. First, a graphite powder is added to an acid solution, filtered, and washed with deionized water. Next, concentrated sulfuric acid and potassium permanganate (KMnO₄) are sequentially added to the graphite oxide (G.O). The graphite oxide is filtered, and metal ions attached to the graphite oxide are then removed by the addition of deionized water and hydrochloric acid. The graphite oxide is filtered through a membrane. The filtered graphite oxide is subjected to sonication and centrifugation. To the resulting solution are added deionized water, a hydrazine solution and ammonia. Stirring of the mixture affords graphene.

The dispersion medium is preferably a mixed solution of an alcohol and magnesium nitrate. The dispersion medium homogeneously disperses the graphene to allow the graphene to be readily deposited on the outer surface of a transparent electrode.

The graphene is preferably added in an amount such that the graphene content of the mixed solution is from 0.00001 to 0.25% by weight. If the graphene content is less than 0.00001% by weight, the deposition effect of the graphene is insignificant. Meanwhile, if the graphene content exceeds 0.25% by weight, the mixed solution becomes highly viscous and results in a gel rather than a solution, making it difficult to appropriately control the content of the graphene deposited by electrophoresis.

Next, a transparent electrode is dipped in the graphene dispersion and a voltage is applied thereto. The transparent electrode is made of a suitable material known in the art, for example, a transparent conductive material. Specific examples of materials for the transparent electrode include, but are not limited to, indium tin oxide (ITO), tin oxide (Sn₂O), zinc oxide (ZnO), and fluorine doped tin oxide (FTO).

The interval between both electrodes during deposition is preferably from 5 mm to 5 cm. Deposition is preferably carried out for 5 seconds to 5 minutes. Within this range, the graphene can be deposited on the surface of the transparent electrode. The final electrode after subsequent annealing at a proper temperature has low resistance, high current density and high efficiency, thus being suitable as a substitute for platinum electrode. If the deposition voltage is applied for too long or too short a period of time, it is difficult to obtain the desired effects of the present invention.

The deposition voltage is preferably from 5 to 60 V. The application of a voltage lower than 5 V causes too low a deposition rate. Meanwhile, the application of a voltage higher than 60 V causes too high a deposition rate, making it difficult to adjust the thickness of the counter electrode to an appropriate level.

Finally, the graphene-deposited transparent electrode is annealed at 350 to 600° C. under a nitrogen atmosphere. The desired effects of the electrode cannot be obtained at an annealing temperature lower than 350° C. Meanwhile, an FTO or glass substrate as the transparent electrode is liable to crack at an annealing temperature higher than 600° C.

In another aspect, the present invention provides a counter electrode produced by adding graphene to a dispersion medium, dipping a transparent electrode in the graphene dispersion, applying a voltage to the transparent electrode to deposit the graphene on the transparent electrode, and annealing the graphene-adsorbed transparent electrode at 350 to 600° C. under a nitrogen atmosphere.

Preferably, the counter electrode of the present invention has a transmittance of at least 60% in the visible region in a state in which the counter electrode is attached to a transparent substrate. The transmittance of the counter electrode varies depending on the deposition voltage and time. Generally, the transmittance of the counter electrode deteriorates as the deposition time increases. Since the transmittance of the counter electrode attached to a transparent substrate is at least 60% in the visible region, loss of transmittance by graphene is not significant.

Preferably, the counter electrode of the present invention has a current density of 10 to 15 mA/cm². The current density of the counter electrode originates from the graphene deposited by electrophoresis and is strongly dependent on the annealing temperature. For example, the counter electrode annealed at a temperature of 350° C. or more may have a current density of at least 10 mA/cm².

In another aspect, the present invention provides a dye-sensitized solar cell including a counter electrode wherein the counter electrode is produced by adding graphene to a dispersion medium, dipping a transparent electrode in the graphene dispersion, applying a voltage to the transparent electrode to deposit the graphene on the transparent electrode, and annealing the graphene-adsorbed transparent electrode at 350 to 600° C. under a nitrogen atmosphere.

The method of the present invention based on electrophoresis enables the production of a counter electrode at low cost and is suitable for uniform coating of graphene on a large area. For these reasons, a counter electrode for a dye-sensitized solar cell can be produced using graphene instead of platinum by electrophoresis instead of screen painting or pasting.

The present invention is not limited to the following preferred examples.

### Examples

### Synthesis of Graphene

6 ml of H₂SO₄ was put in a vial on a hot plate and heated to 80° C. K₂S₂O₈ and P₂O₅ (2 g) were weighed using an electronic scale and slowly added to the vial, followed by the addition of 4 g of a graphite powder. After completion of the reaction, the reaction mixture was cooled at room temperature (25° C.) for 6 hr. The graphite powder was filtered through a filter paper. Deionized water was continuously poured on the filtered graphite powder to wash the graphite powder. This procedure was repeated until the water reached pH 7. After filtration and washing, the graphite powder was dried at room temperature (25° C.) overnight, giving graphite oxide.

A stirring bar was put in a Teflon beaker. The Teflon beaker, ice and salt were placed in an icebox on a magnetic stirrer. Concentrated H₂SO₄ (92 ml) and the graphite oxide (G.O) were added to the Teflon beaker. 12 g of KMnO₄ was added portionwise to the Teflon beaker while maintaining the internal temperature of the Teflon beaker at a maximum of 20° C. After the reaction was stabilized, the reaction mixture was stirred at 35° C. for 2 hr. 185 ml of deionized water was slowly added to the reaction mixture. After 15 min, 560 ml of deionized water and 10 ml of 30% H₂O₂ were added. The resulting mixture was allowed to stand until it turned light yellow.

Thereafter, the resulting graphite oxide (G.O) was filtered and 1 liter of a solution of deionized water (DI) and hydrochloric acid (HCl) (10:1, DI=818, HCl=182) was slowly poured thereon to remove the metal ions attached to the graphite oxide (G.O.). The graphite oxide (G.O) remaining on filter paper was added to deionized water (800 ml). The deionized water turned brown and became viscous. The graphite oxide (G.O) was filtered through a dialysis membrane to obtain 0.5% w/v G.O.

The filtered G.O was centrifuged at 3,000 rpm for 30 min in a 14 cm-diameter disk centrifuge. As a result of the centrifugation, unpeeled graphite oxide was separated. 5 ml of the resulting solution, 5 ml of deionized water, 5 pl of a hydrazine solution (35 wt %), and 35 μl of ammonia (28 wt %) were put in a vial. After vigorous stirring for several minutes, the vial was allowed to stand in water at 95° C. for 1 hr, affording 0.25 wt % of chemically converted graphene (CCG).

### Production of Counter Electrodes Based on Electrophoresis

### Example 1

1 ml of a solution of the synthesized graphene (0.25 wt %), 15 mg of magnesium nitrate [Mg(NO₃)₂.6H₂O, Sigma Aldrich], and 100 ml of ethanol were put in a vial. The mixture was dispersed in an ultrasonic cleaner for 1 hr to prepare a mixed solution. Stainless steel as an opposite electrode and FTO glass (sheet resistance=15 Ωcm²) as a transparent electrode were dipped in the mixed solution. The interval between the two electrodes was adjusted to 5 mm. A voltage of 10 V was applied to the electrodes at room temperature for 10 sec to deposit the graphene. The graphene-deposited electrode was primarily dried at room temperature, heated for 30 sec, annealed at 600° C. for 1 min under a nitrogen atmosphere using a rapid thermal annealing (RTA) system, and cooled in air.

### Example 2

The procedure of Example 1 was repeated except that the deposition time was changed to 5 sec.

### Example 3

The procedure of Example 1 was repeated except that the deposition time was changed to 15 sec.

### Example 4

The procedure of Example 1 was repeated except that the deposition time was changed to 30 sec.

### Example 5

The procedure of Example 1 was repeated except that the deposition voltage was changed to 20 V.

### Example 6

The procedure of Example 1 was repeated except that the deposition voltage and time were changed to 20 V and 5 sec, respectively.

### Example 7

The procedure of Example 1 was repeated except that the deposition voltage and time were changed to 20 V and 15 sec, respectively.

### Example 8

The procedure of Example 1 was repeated except that the deposition voltage and time were changed to 20 V and 30 sec, respectively.

### Example 9

The procedure of Example 1 was repeated except that the deposition voltage was changed to 30 V.

### Example 10

The procedure of Example 1 was repeated except that the deposition voltage and time were changed to 30 V and 5 sec, respectively.

### Example 11

The procedure of Example 1 was repeated except that the deposition voltage and time were changed to 30 V and 15 sec, respectively.

### Example 12

The procedure of Example 1 was repeated except that the deposition voltage and time were changed to 30 V and 30 sec, respectively.

### Fabrication of Dye-Sensitized Solar Cells (Type 1)

In order to evaluate the performance of each of the graphene counter electrodes, a dye-sensitized solar cell was fabricated using the graphene counter electrode, an electrolyte (AN-50, Solaronix), a transparent electrode (FTO, 15 Ω/cm², WOOYANG GMS), a sealing film (Surlyn 60 μm, Solaronix), TiO₂ (HT/SP, Solaronix), and a dye (N-719, Timo dyesol). The TiO₂ and the dye constituted a working electrode. The TiO₂ layer of the working electrode was about 30 μm thick. The areas of the working electrode and the counter electrode were 0.12 cm² (0.3 cm×0.4 cm) and 0.3 cm² (0.5 cm×0.6 cm), respectively.

### Fabridcation of Dye-Sensitized Solar Cells (Type 2)

In order to evaluate the performance of each of the graphene counter electrodes, a dye-sensitized solar cell was fabricated using the graphene counter electrode, an electrolyte (AN-50, Solaronix), a transparent electrode (FTO, 15 Ω/cm², WOOYANG GMS), and a sealing film (Surlyn 60 μm, Solaronix).

TiO₂ (WER4-O, 18NR-AO, 18NR-T, Timo-dyesol) and a dye (N-719, Timo dyesol) were used to constitute a working electrode. The TiO₂ layer of the working electrode had an about 30 μm thick multilayer structure. The areas of the working electrode and the counter electrode were 0.08 cm² (0.2 cm×0.4 cm) and 0.36 cm² (0.6 cm×0.6 cm), respectively.

### Evaluation and Results

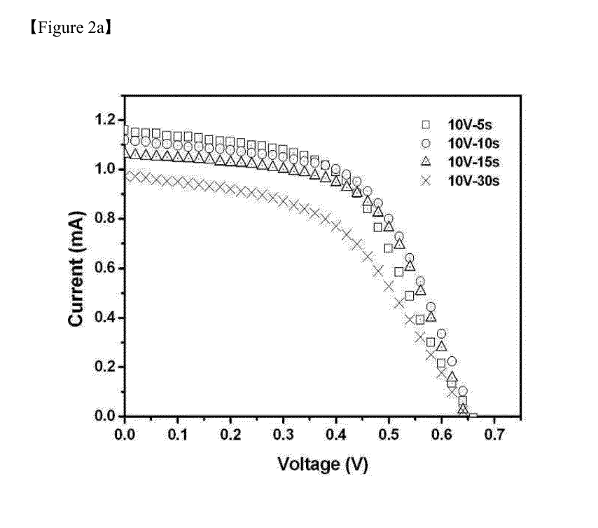

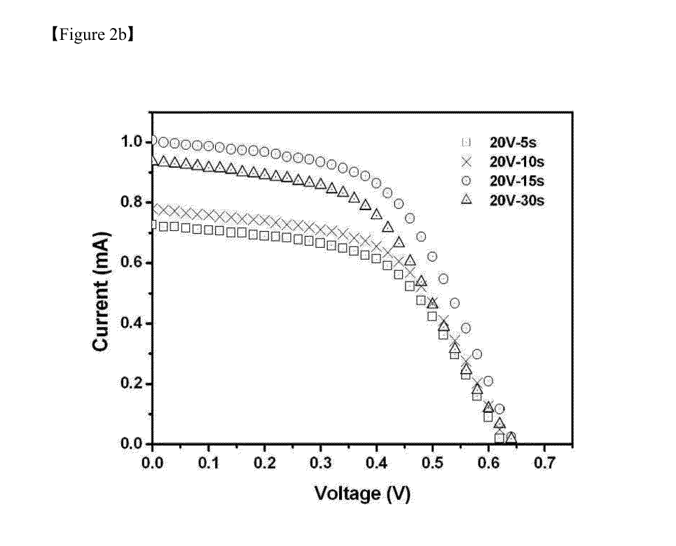

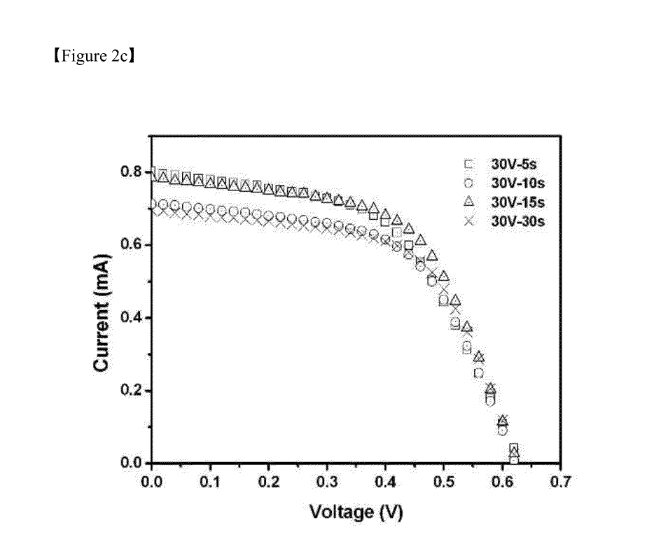

FIGS. 2a to 2c show I-V curves of the dye-sensitized solar cells fabricated using the graphene counter electrodes, which were produced by the application of different electrophoretic deposition voltages for different times in Examples 1-12. The I-V curves were measured under 1 sun, A.M. 1.5 illumination and the area of each cell was 0.12 cm². The open-circuit voltages, short-circuit currents, and fill factors of the solar cells were determined from the I-V curves.

The open-circuit voltage (V_{oc}) is located at the intercept with the x-axis in the I-V curve and is a potential difference between both terminals of the solar cell when light is irradiated in a state in which the circuit is open, i.e. the impedance approaches infinity.

The short-circuit current (J_{sc}) is located at the intercept with the y-axis in the I-V curve and is a current value in the reverse direction (negative value) when light is irradiated in a state in which the circuit is shorted, i.e. there is no external resistance.

The fill factor (FF) is a value obtained by dividing Vₘₚ×Jₘₚ by V_{oc}×J_{sc}, where Vₘₚ is the current density and Jₘₚ is the voltage at the maximum electric power voltage. That is, fill factor is a measure of how rectangular the I-V curve is.

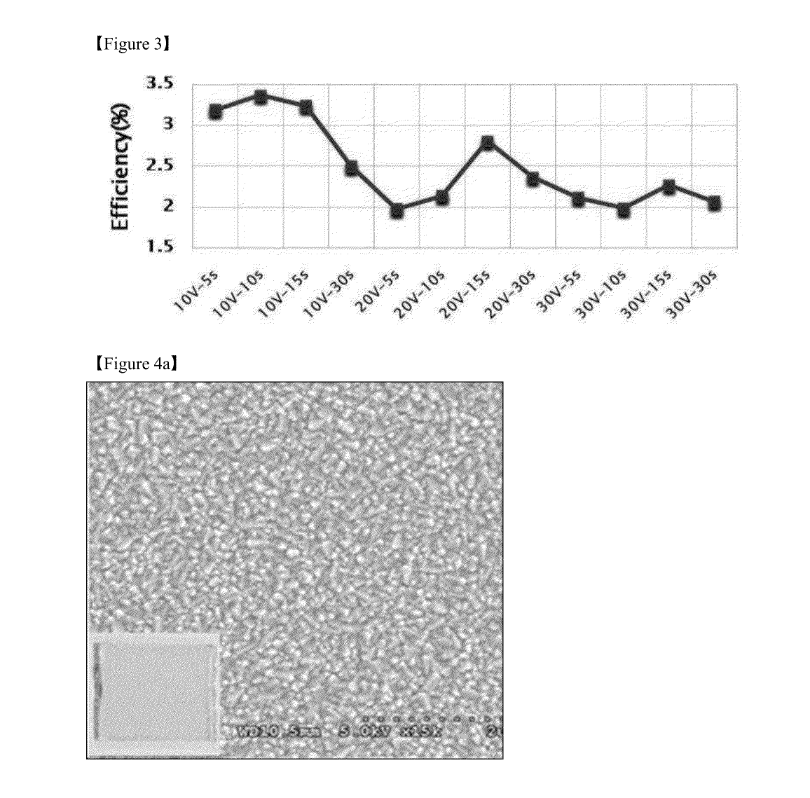

FIG. 3 shows the efficiency values of the dye-sensitized solar cells. Referring to FIG. 3, the efficiencies of the solar cells varied depending on the applied voltages and deposition times.

### SEM and TEM Analyses

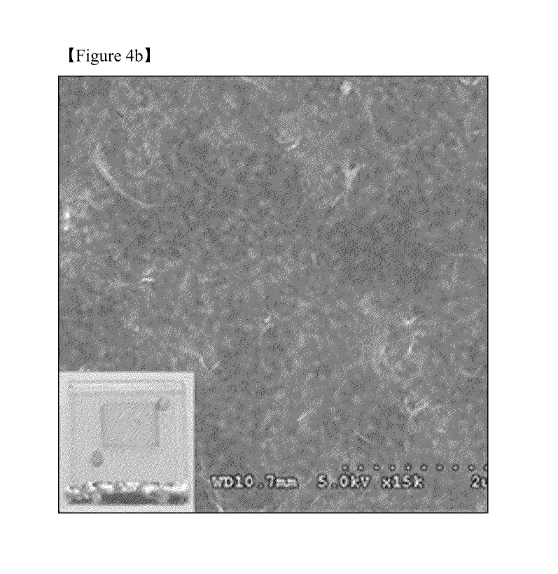

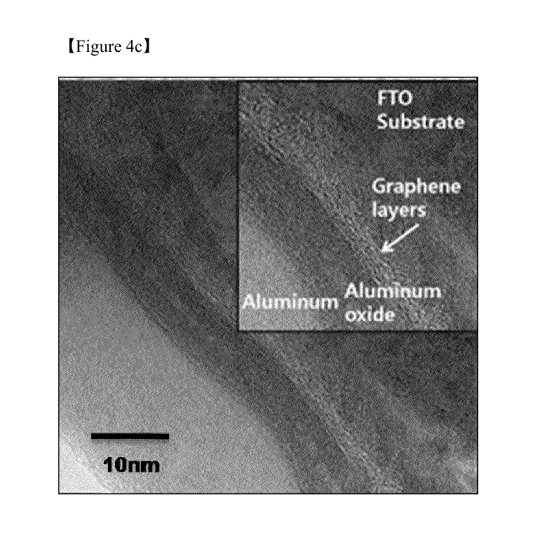

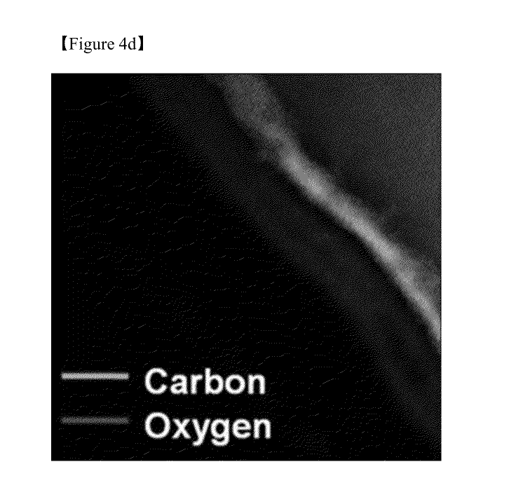

FIGS. 4a and 4b are surface SEM and TEM images of the FTO substrate before and after graphene deposition. FIGS. 4a and 4b show that the graphene was deposited on the FTO substrate. FIG. 4c is a cross-sectional HR-TEM image of the graphene-deposited FTO substrate. FIG. 4d shows the results of EELS analysis for the graphene-deposited FTO substrate. As can be seen from FIGS. 4c and 4d, the graphene was deposited to a thickness of around 5 nm.

### Thermal Gravity Analysis

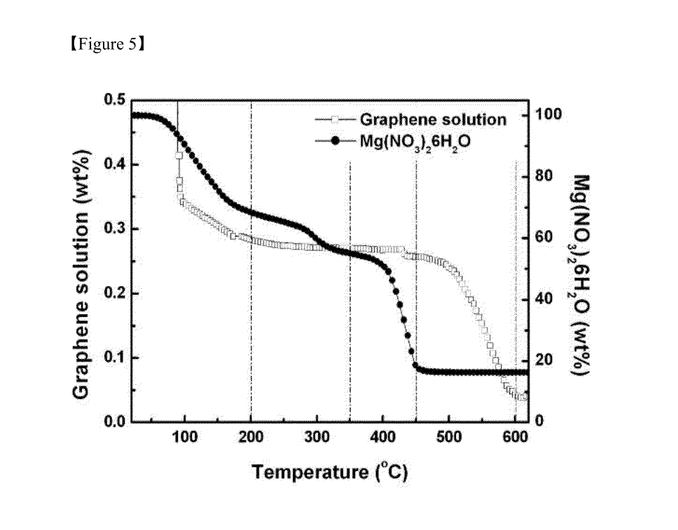

FIG. 5 shows the results of thermal gravity analysis for magnesium nitrate and the graphene solution to determine annealing temperatures. The annealing temperature range was determined from data of thermal gravity analysis for Mg(NO₃)₂.6H₂O and the graphene solution used in the electrophoresis. Referring to FIG. 5, the graphene solution underwent a sharp weight loss at temperatures up to about 200° C., which resulted from the removal of water and labile oxygen reactive groups (CO, CO₂). For magnesium nitrate, a primary weight loss was observed between 300 and 400° C. and a secondary weight loss was observed at 450° C. A final weight loss of the graphene solution was observed at 600° C. From these observations, 200, 350, 450, and 600° C. were determined as annealing temperatures.

### Nyquist Plots

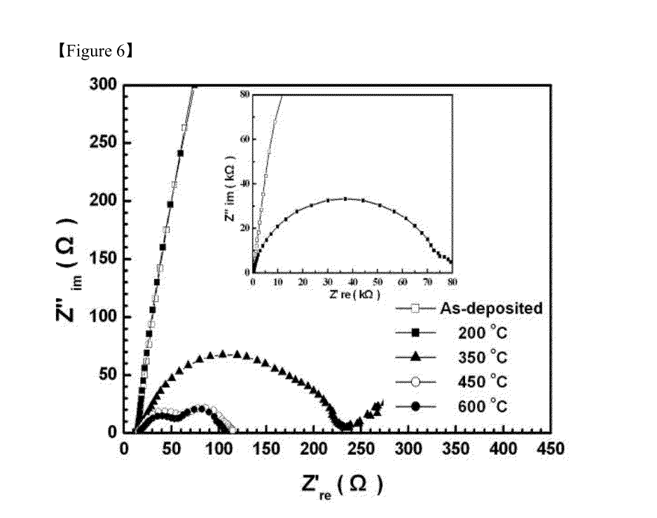

Nyquist plots of the dye-sensitized solar cells (type 2) fabricated using the graphene electrodes having undergone annealing at the predetermined temperatures were measured under 1 sun, A.M. 1.5 illumination. The results are shown in FIG. 6. The size of the first half-circle from the left in FIG. 6 indicates the resistance between the counter electrode and the electrolyte. The resistance of the sample having undergone no annealing was impossible to measure. The sample having undergone annealing at 200° C. showed a resistance of about 75,000 Ω, the sample having undergone annealing at 350° C. showed a resistance of 225 Ω, the sample having undergone annealing at 450° C. showed a resistance of 46 Ω, and the sample having undergone annealing at 600° C. showed a resistance of 38 Ω. These results lead to the conclusion that the resistance between the electrolyte and the counter electrode decreases with increasing annealing temperature. Particularly, sharply decreased resistances were observed in the samples having undergone annealing at 350° C. or higher.

### Bode Phases

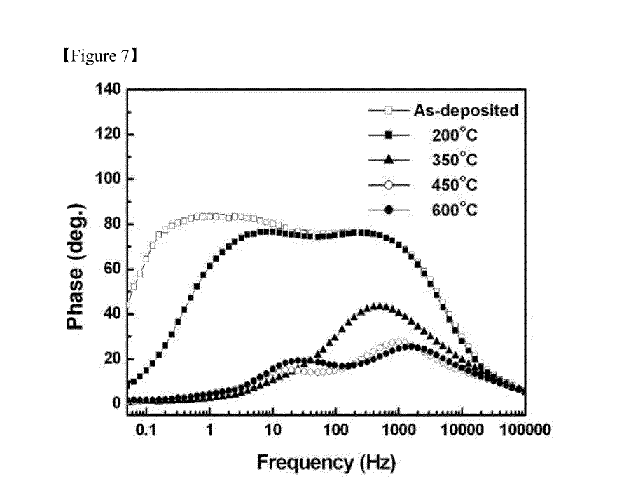

Bode phase plots of the dye-sensitized solar cells (type 2) fabricated using the graphene electrodes having undergone annealing at the predetermined temperatures were measured under 1 sun, A.M. 1.5 illumination. The results are shown in FIG. 7. Referring to FIG. 7, each of the peaks observed in the higher frequency band (toward the right) indicates the reaction rates between the electrolyte and the counter electrode. The reaction frequencies of the sample having undergone no annealing and the sample having undergone annealing at 200° C. were observed at 220 Hz, the reaction frequency of the sample having undergone annealing at 350° C. was observed at 400 Hz, the reaction frequency of the sample having undergone annealing at 450° C. was observed at 1000 Hz, and the reaction frequency of the sample having undergone annealing at 600° C. was observed at 2000 Hz. From these observations, it can be concluded that the reaction rate of graphene increases with increasing annealing temperature.

### I-V Curves

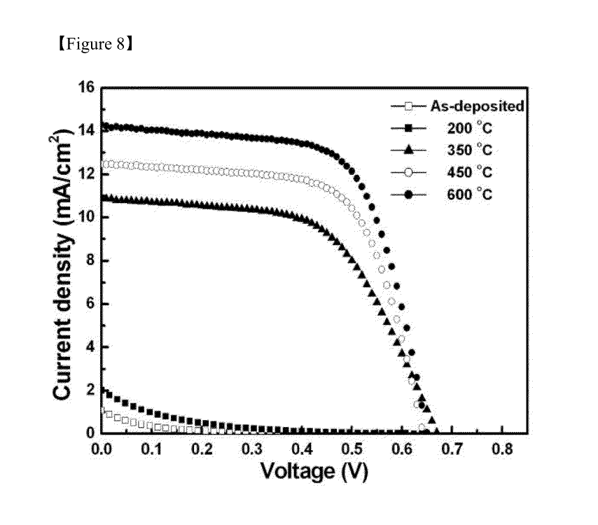

I-V curves of the dye-sensitized solar cells (type 2) fabricated using the graphene electrodes having undergone annealing at the predetermined temperatures were measured under 1 sun, A.M. 1.5 illumination. The results are shown in FIG. 8. As can be seen from FIG. 8, the performance characteristics of the dye-sensitized solar cells including the graphene electrodes having undergone annealing at the predetermined temperatures were improved. The resistance, fill factor, current density, and efficiency values of the dye-sensitized solar cells are summarized in Table 1.

Referring to FIG. 8 and Table 1, it can be concluded that the fill factors, current densities and efficiencies of the dye-sensitized solar cells increase with increasing annealing temperature. Particularly, the characteristics of the dye-sensitized solar cells including the graphene electrodes having undergone annealing at temperatures of 350° C. or higher were markedly improved.

TABLE 1

| | Redox | | | Jsc | | Effi- |
|---|---|---|---|---|---|---|
| | Frequency | R_{d1} | Voc | (mA/ | Fill | ciency |
| | on GCEs (Hz) | (Ω) | (V) | cm²) | Factor | (%) |
| As-deposited | 220 | — | 0.481 | 10.8 | 0.252 | 0.06 |
| 200° C. | 220 | 75,000 | 0.615 | 2.01 | 0.254 | 0.15 |
| 350° C. | 400 | 225 | 0.671 | 10.91 | 0.549 | 4.13 |
| 450° C. | 1000 | 46 | 0.643 | 12.46 | 0.642 | 5.08 |
| 600° C. | 2000 | 38 | 0.651 | 14.29 | 0.653 | 5.69 |

### XPS Data

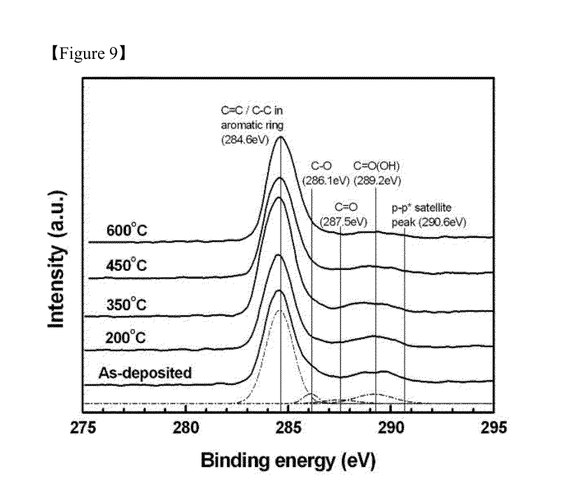

XPS data were obtained to analyze a cause of the improved performance characteristics of the samples having undergone annealing at the predetermined temperatures. The results are shown in FIG. 9. Referring to FIG. 9, the performance characteristics of the samples having undergone annealing at 200° C. or higher were markedly improved. These results appear to be due to the removal of water from the samples by annealing. As can be seen from FIG. 9, the intensities of the peaks corresponding to C—O, C═O and C═O(OH) groups were gradually diminished. These results confirm that the removal of the oxygen groups is a cause of the increased conductivity and reactivity of the graphene electrodes.

### Transmittance Analysis

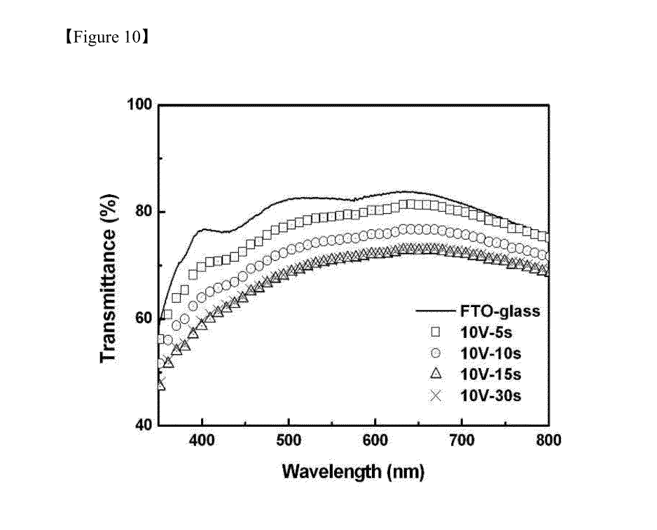

The transmittance values of the graphene electrodes were measured and the characteristics of the dye-sensitized solar cells including the graphene electrodes were evaluated. The transmittance of each of the counter electrodes produced in Examples 1-4 in the visible region was measured in a state in which the counter electrode was attached to the FTO substrate. The analytical results are shown in FIG. 10. Referring to FIG. 10, the transmittance values of the counter electrodes are slightly different depending on the deposition voltage and time, but are at least 60% in the visible region.

1. A method for producing a counter electrode, comprising:
adding graphene to a dispersion medium to prepare a graphene dispersion;
dipping a transparent electrode in the graphene dispersion and applying a voltage to the transparent electrode for 5 seconds to 5 minutes to deposit the graphene on the transparent electrode; and
annealing the graphene-adsorbed transparent electrode at 350 to 600° C. under a nitrogen atmosphere.

2. The method according to claim 1, wherein the graphene is present in an amount of 0.00001 to 0.25% by weight, based on the weight of the graphene dispersion.

3. The method according to claim 1, wherein the deposition voltage is from 10 to 30 V.

4. The method according to claim 3, wherein the graphene is produced by a chemical synthesis process.

5. The method according to claim 1, wherein the dispersion medium is a mixed solution of an alcohol and magnesium nitrate.

6. A counter electrode produced by adding graphene to a dispersion medium, dipping a transparent electrode in the graphene dispersion, applying a voltage to the transparent electrode to deposit the graphene on the transparent electrode, and annealing the graphene-adsorbed transparent electrode at 350 to 600° C. under a nitrogen atmosphere.

7. The counter electrode according to claim 6, wherein the counter electrode has a transmittance of at least 60% in the visible region in a state in which the counter electrode is attached to a transparent substrate.

8. The counter electrode according to claim 6, wherein the counter electrode has a current density of 10 to 15 mA/cm².

9. A dye-sensitized solar cell fabricated using the counter electrode according to claim 6.
